(19) United States
(12) Patent Application Publication
(10) Pub. No.: US 2011/0069518 A1
(43) Pub. Date: Mar. 24, 2011

(54) RESONANT INVERTER OF RADIO FREQUENCY GENERATOR FOR RADIOFREQUENCY ABLATION

(75) Inventors: Kyong-Min SHIN, Seoul (KR); Hong-chea Jung, Gimpo-si (KR); Young-Jin Choi, Seoul (KR); Jun-hyok Lee, Kimpo-si (KR); Jae-Bok Kim, Suwon-si (KR); Guk-joo Na, Kimpo-si (KR); Kye-joo Kim, Kimpo-si (KR)

(73) Assignees: Taewoong Medical Co., Ltd., Kimpo-si (KR); Kyong Min SHIN, Seoul (KR)

(21) Appl. No.: 12/730,713

(22) Filed: Mar. 24, 2010

(30) Foreign Application Priority Data
Sep. 23, 2009 (KR) 10-2009-009123

(51) Int. Cl. H02M 7/02

(52) U.S. Cl. 363/140

(57) ABSTRACT

Disclosed herein is the resonant inverter of a radio frequency (RF) generator for radiofrequency ablation (RFA). The resonant inverter of RF generator for RFA amplifies to high power an oscillation frequency output from an oscillator and provides the amplified oscillation frequency to an electrode. The resonant inverter processes the oscillation frequency output from the oscillator as a high-power sine wave having a frequency of 480 kHz and a Root Mean Square (RMS) power of 30 to 200 watts, and transfers the high-power sine wave to the electrode.

### BACKGROUND OF THE INVENTION

1. Field of the Invention

The present invention relates, in general, to the resonant inverter of a radio frequency (RF) generator for high-efficiency and high-precision radiofrequency ablation (RFA) which does not cause electromagnetic interference (EMI) with surround medical instruments at the time of performing surgery on cancerous tissue in places such as the liver or the thyroid gland. More particularly, the present invention relates to the resonant inverter of an RF generator for RFA, which can have a Root Mean Square (RMS) output of 30 to 200 watts when an output frequency from a clock oscillator is provided to an electrode as a sine wave having a frequency of 480 kHz.

2. Description of the Related Art

Generally, as methods of treating cancerous tissue generated in the bodily organs of a human being, for example, the liver, there are methods of suppressing the growth of cancerous tissue and eliminating the cancerous tissue using drugs and radiotherapy without performing surgery, and methods of surgically eliminating cancerous tissue by performing surgery.

Of the above-described treatment methods, the methods of surgically eliminating cancerous tissue are disadvantageous in that, since a region around a lesion at which cancerous tissue is located must be excised, the region to be excised is very wide, so that the surgery itself is very difficult, and much time is required for a region operated on to recover completely, and, in addition, a large scar remains on the region after recovery.

In particular, cancerous tissue or the like frequently recurs, and, when this happens, the region around the previously excised lesion must be excised again, thus not only inflicting pain because of the surgery putting the patient at high risk, but also imposing an economic burden.

Accordingly, recently, methods of eliminating cancerous tissue without performing surgery, that is, methods such as transarterial chemoembolization, percutaneous ethanol injection (PEI), systemic chemotherapy, and local thermal therapy, have been widely performed. Among these methods, local thermal therapy is the most effective method of the methods which are widely performed.

The above-described local thermal therapy includes radiofrequency ablation (RFA), microwave ablation, laser ablation, etc. Among these methods, RFA is the most effective method. Such RFA is a method of ablating and destroying only cancerous tissue using RF heat without excising the cancerous tissue when it occurs in a bodily organ, for example, the liver.

In accordance with an embodiment, an apparatus for removing cancerous tissue (cells) by means of RFA as described above may include an RF generator for radiofrequency ablation which generates a radio frequency of a predetermined level, and a single electrode to which the radio frequency generated by the RF generator for RFA is applied.

Meanwhile, the ‘multi-RF generator for radiofrequency ablation’ disclosed in Korean Patent No. 10-739002, which was filed and registered, proposes a technology which not only can extend the range of ablation, but also can improve on safety while efficiently destroying a large-sized cancer tumor by providing radio frequencies from a single RF generator for RFA to a plurality of electrodes, and which enables RFA to be simultaneously performed on two lesions by controlling one or more channels.

However, the RF generator for RFA is a device which is capable of heating and destroying cancerous tissue in places such as the liver or the thyroid gland through an electrode at the time of performing surgery on the cancerous tissue with high power of 30 to 200 W at a frequency of 480 kHz, and which causes electromagnetic interference with surrounding medical instruments. In particular, a diagnostic imaging device such as a diagnostic ultrasound system for providing images of a region being operated on to a medical team is used together with the RF generator for RFA. Such a diagnostic imaging device is a device sensitive to electromagnetic waves, and may occasionally not provide clear images to the medical team due to electromagnetic waves generated by the RF generator for RFA.

The ultrasound probe of the diagnostic ultrasound system uses a frequency band of 4 MHz to 13 MHz according to the purpose thereof. Here, since 480 kHz harmonics (2nd, 3rd, . . . , Nth harmonics) generated by the RF generator for RFA are distributed in the frequency band used by the diagnostic ultrasound system, they cause interference with diagnostic images. In particular, a push-pull method used in the RF generator for RFA is disadvantageous because a large number of radio frequencies are generated and the output impedance of the RF generator is capacitive impedance, and thus it is difficult to perform impedance matching with the capacitive load of biological cells and to perform cauterization efficiently.

FIG. 1 is a diagram showing an example of a conventional RF generator for RFA. Switches S11 and S12 are electronic switches which are generally implemented as power metal-oxide-semiconductor field-Effect transistors (MOSFETs). The switches S11 and S12 have operating timing with a phase difference of 180°, wherein the switch S11 takes charge of the positive cycle of a square wave and the switch S12 takes charge of the negative cycle of the square wave.

While high voltage (HV) is being applied to a transformer T11, an Alternating Current (AC) square wave signal, which is transferred to the primary coil of a transformer T12 via capacitors C11 and C12 when the switches S11 and S12 are operated, resonates in parallel due to the inductance Lt2 of the secondary coil of the transformer T12 and the capacitance of a capacitor C13. This resonant signal is transferred to an electrode 101 via a capacitor C14.

In this case, the output impedance becomes capacitive because of the capacitor C14.

The above-described RF generator is problematic in that loss occurs on a signal while the signal passes through the two transformers T11 and T12, and a resonant circuit is connected to a load side, so that the quality factor Q of the resonant circuit decreases according to the magnitude of the load, thus distorting a sine wave signal and increasing harmonics.

### SUMMARY OF THE INVENTION

Accordingly, the present invention has been made keeping in mind the above problems occurring in the prior art, and an object of the present invention is to provide the resonant inverter of an RF generator for radiofrequency ablation (RFA), which can provide a stable RF signal, the output waveform of which is similar to a sine wave and which has high efficiency.

In order to accomplish the above object, the present invention provides a resonant inverter of a radio frequency (RF) generator for radiofrequency ablation (RFA), the resonant inverter amplifying to high power an oscillation frequency output from an oscillator and providing the amplified oscillation frequency to an electrode, wherein the resonant inverter processes the oscillation frequency output from the oscillator as a high-power sine wave having a frequency of 480 kHz and a Root Mean Square (RMS) power of 30 to 200 watts, and transfers the high-power sine wave to the electrode.

Preferably, the resonant inverter comprises a series resonant circuit unit in which an inductor and a first capacitor are connected in series so as to generate a resonant frequency identical to the oscillation frequency required to switch high voltage that is supplied to the resonant inverter, and a parallel resonant circuit unit in which a second capacitor and a primary coil of a transformer are connected in parallel so as to perform secondary resonance on an output of the series resonant circuit unit and transmit a pure sine wave AC output to the electrode.

Preferably, the inductor is made of ferrite material having a high quality factor (Q), thus improving energy efficiency.

Preferably, the inductor is implemented as a single coil.

Preferably, an inductive transformer is connected between the resonant inverter and the electrode as output impedance, so that the output impedance cancels capacitive impedance of a biological cell, and thus maximum power relative to a pure resistance component of the biological cell can be supplied.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a conventional RF generator for radiofrequency ablation (RFA); and

FIG. 2 is a diagram showing an RF generator for RFA according to the present invention.

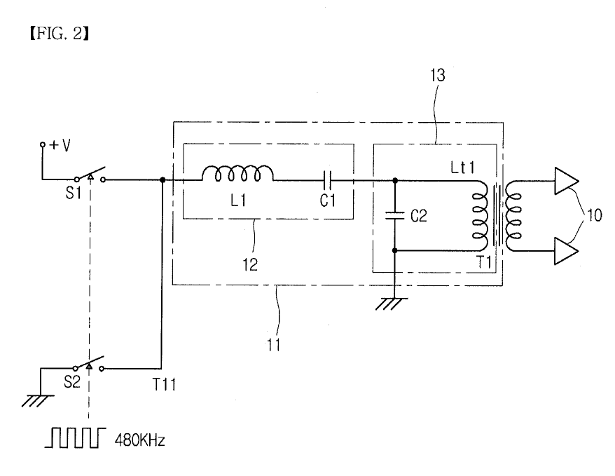

### DESCRIPTION OF THE PREFERRED EMBODIMENTS

Hereinafter, embodiments of the present invention will be described in detail with reference to the attached drawings.

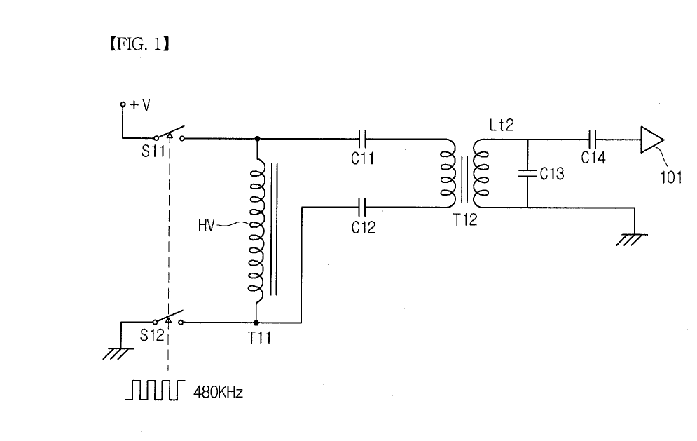

FIG. 1 is a diagram showing the resonant inverter of a radio frequency (RF) generator for radiofrequency ablation (RFA) according to the present invention. In the present invention, a resonant inverter 11 is arranged, so that when an oscillation frequency output from an oscillator (not shown) is amplified to high power and is provided to electrodes 10, the oscillation frequency from the oscillator can be processed as a high-power sine wave having a frequency of 480 kHz and a Root Mean Square (RMS) power of 30 to 200 watts and can be transferred to the electrodes 10.

The resonant inverter 11 is disposed between the electrodes 10 and two switches S1 and S2 which receive high voltage (HV) and are alternately switched in response to the 480 kHz oscillation frequency provided by the oscillator. The resonant inverter 11 includes a series resonant circuit unit 12 and a parallel resonant circuit unit 13. The series resonant circuit unit 12 has a structure in which an inductor L1 and a capacitor C1 are connected in series so as to generate a resonant frequency identical to the oscillation frequency required to switch the high voltage (HV) that is supplied to the resonant inverter 11. The parallel resonant circuit unit 13 has a structure in which a capacitor C2 and the primary coil of a transformer T1 are connected in parallel so as to perform secondary resonance on the output of the series resonant circuit unit 12 and transmit pure sine wave AC output to the electrodes 10.

Here, the inductor L1 is made of ferrite material having a high quality factor Q, thus improving energy efficiency. Further, the inductor L1 implemented as a single coil is used, and thus the manufacture thereof is simplified and the high quality factor Q can be obtained.

Further, in the present invention, the inductive transformer T1 is connected between the resonant inverter 11 and the electrodes 10 as output impedance, so that the output impedance cancels the capacitive impedance of a biological cell, and thus the maximum power relative to the pure resistance component of the biological cell can be supplied.

An example of the operation of the present invention will be described in detail.

Prior to the description of the operation, the switch S1 having one end to which the high voltage (HV) is applied and the switch S2 having one end which is grounded will be described. These switches may be electronic switches, for example, power MOSFETs. Similarly to those of the conventional technology, the switches S1 and S2 have operating timing with a phase difference of 180°, wherein the switch S1 takes charge of the positive cycle of a square wave and the switch S2 takes charge of the negative cycle of the square wave.

When the switch S1 is switched to an “ON” state by the oscillation frequency provided by an oscillator (not shown), that is, switching frequency, charge current attributable to the high voltage (HV) flows through the series resonant circuit unit 12, that is, the inductor L1 and the capacitor C1. When the switch S2 is switched again to an “ON” state and the switch S1 is switched again to an “OFF” state due to the switching frequency, discharge current flows in a reverse direction.

When the switching frequency is assumed to be ‘F_{c}’, and the series resonant frequency of the following Equation (1) is identical to the switching frequency by the inductor L1 and the capacitor C1, only a fundamental wave among square wave current components passes through the resonant inverter, and is then transferred to the load R, that is, the electrodes 10,

$${F}_{rs} = \frac{1}{2} π \sqrt{L 1 C 1} \qquad ( 1 )$$

where Fᵣₛ is the serial resonant frequency.

Further, the resonant frequency obtained as described above is converted into a parallel resonant frequency of the following Equation (2) through secondary resonance performed by the parallel resonant circuit unit 13, that is, the capacitor C2 and the primary coil of the transformer T1, so that pure sine wave AC output is applied to the electrodes 10 via the transformer T1,

$${F}_{rp} = \frac{1}{2} π \sqrt{LtC 2} \qquad ( 2 )$$

where Fᵣₚ is the parallel resonant frequency.

As described above, the present invention is advantageous in that, since a series resonant inductor implemented as a single coil is used, the resonant inverter of the present invention can be simply manufactured, a high quality factor Q can be obtained, and it is easy to match the inductance of the inductor with the capacitance of a standard capacitor.

Further, the present invention is advantageous in that, instead of a load resistor (R), a coupling transformer and a capacitor are connected in parallel to induce secondary W resonance, thus enabling a fundamental frequency to be filtered once more.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A resonant inverter of a radio frequency (RF) generator for radiofrequency ablation (RFA), the resonant inverter amplifying to high power an oscillation frequency output from an oscillator and providing the amplified oscillation frequency to an electrode, wherein:
the resonant inverter processes the oscillation frequency output from the oscillator as a high-power sine wave having a frequency of 480 kHz and a Root Mean Square (RMS) power of 30 to 200 watts, and transfers the high-power sine wave to the electrode.

2. The resonant inverter according to claim 1, comprising:
a series resonant circuit unit in which an inductor and a first capacitor are connected in series so as to generate a resonant frequency identical to the oscillation frequency required to switch high voltage that is supplied to the resonant inverter; and
a parallel resonant circuit unit in which a second capacitor and a primary coil of a transformer are connected in parallel so as to perform secondary resonance on an output of the series resonant circuit unit and transmit a pure sine wave AC output to the electrode.

3. The resonant inverter according to claim 2, wherein the inductor is made of ferrite material having a high quality factor (Q), thus improving energy efficiency.

4. The resonant inverter according to claim 2, wherein the inductor is implemented as a single coil.

5. The resonant inverter according to claim 1, wherein an inductive transformer is connected between the resonant inverter and the electrode as output impedance, so that the output impedance cancels capacitive impedance of a biological cell, and thus maximum power relative to a pure resistance component of the biological cell can be supplied.
